(19) United States
(12) Patent Application Publication
(10) Pub. No.: US 2013/0024353 A1
(43) Pub. Date: Jan. 24, 2013

(54) INTERVAL PRICE LIMIT

(71) Applicant: IntercontinentalExchange, Inc., Atlanta, GA (US)

(72) Inventors: Charles A. Vice, Roswell, GA (US); Thomas Farley, New York, NY (US); Edward Baginski, Alpharetta, GA (US); Greg Hamamgian, Woodstock, GA (US); Simon Shlyayfer, Smyrna, GA (US); Mayur Kapani, Marietta, GA (US); Petre Alexandrescu, Bucuresti Sec (RO)

(73) Assignee: IntercontinentalExchange, Inc., Atlanta, GA (US)

(21) Appl. No.: 13/625,423

(22) Filed: Sep. 24, 2012

Related U.S. Application Data
(60) Provisional application No. 61/539,610, filed on Sep. 27, 2011.

(51) Int. Cl. G06Q 40/04

(52) U.S. Cl. 705/37

(57) ABSTRACT

Systems and methods of limiting price movement of a financial instrument include establishing, via an exchange server comprising at least one matching engine module, an interval price limit (IPL) period that defines a predetermined length of time commencing at a start time, and an IPL amount that defines a permissible increase or decrease in an anchor price of a financial instrument during the IPL period. Buy and sell orders received for the financial instrument during the IPL period are matched to generate at least one matched trade having a trade price. The trade price is compared to the anchor price, and if the trade price is within the IPL amount of the anchor price, the matching engine module executes the at least one matched trade. Otherwise, if it is not, the matching engine module is prevented from executing the matched trade.

### CROSS REFERENCE TO RELATED APPLICATION

This Application claims priority to U.S. Provisional Patent Application No. 61/539,610 filed Sep. 27, 2011, the contents of which are incorporated herein in its entirety.

### TECHNICAL FIELD

The disclosure is generally related to limiting unwanted price movement of a financial instrument.

### BACKGROUND

Sharp price movements (either on the buy side or sell side) of financial instruments over relatively short periods of time can adversely affect financial markets, and even cause a market to crash. Accordingly, there is a need for a system and method of recognizing and limiting such unwanted price movements, all without unduly hindering trading activities.

### SUMMARY

Systems and methods of limiting price movement of a financial instrument include establishing, via an exchange server comprising at least one matching engine module, an interval price limit (IPL) period that defines a predetermined length of time commencing at a start time, and an IPL amount that defines a permissible increase or decrease in an anchor price of a financial instrument during the IPL period. Buy and sell orders received for the financial instrument during the IPL period are matched to generating at least one matched trade having a trade price. The trade price is then compared to the anchor price, and if the trade price is within the IPL amount of the anchor price, the matching engine module executes the at least one matched trade. Otherwise, if it is not, the matching engine module is prevented from executing the matched trade.

### BRIEF DESCRIPTION OF THE DRAWINGS

The foregoing summary and the following detailed description are better understood when read in conjunction with the appended drawings. Exemplary embodiments are shown in the drawings, however, it is understood that the embodiments are not limited to the specific methods and instrumentalities depicted herein. In the drawings:

FIG. 1 illustrates an exemplary method of limiting unwanted price movement in accordance with the present disclosure; and

FIG. 2 illustrates an exemplary system of limiting unwanted price movement in accordance with the present disclosure.

### DETAILED DESCRIPTION

The present disclosure relates generally to systems, methods, and apparatus for preventing unwanted short term price movement in financial markets, while at the same time enabling trading participants to continue trading in the affected financial markets. The following definitions and descriptions are provided, and may be useful to better understand the concepts described herein:

“anchor price” refers to a benchmark or a current market value or price level of a given financial instrument;

“financial instrument” refers to a tradable asset of any kind, including cash; evidence of an ownership interest in an entity; or a contractual right to receive, or deliver, cash or another financial instrument. Examples of financial instruments include, without limit, securities, stocks, stock options, loans, commercial paper, bonds, derivative instruments (e.g., forwards, futures, options, swaps, etc.), etc.

“IPL” shall mean interval price limit:
a. “IPL amount” refers to the maximum permissible increase or decrease in price of a particular financial instrument, as calculated from the anchor price, during a given IPL period. Optionally, IPL amount may be specified in terms of ticks or price points (i.e., 0.01). As an example, if the anchor price of a financial instrument is $25.00, and the IPL amount is 50 ticks, then the price of the instrument may increase to a maximum of $25.50 (calculated as the anchor price plus the IPL amount) or decrease to a minimum of $24.50 (calculated as the anchor price minus the IPL amount) during a given IPL period. These maximum and minimum prices refer to the IPL range or IPL band for the respective IPL period;
b. “IPL hold period” or “hold period” refers to a predetermined period of time during which financial instruments are not permitted to trade at prices that are outside of the IPL range (i.e., the anchor price plus or minus the IPL amount) that was established at the start of the current IPL period. As further detailed below, other trading activities remain active during the hold period. Any number of events can trigger a hold period, such as (without limit) receiving a buy order (or a sell order) with a price that is outside of the IPL range. Optionally, once a hold period is triggered, a notice (e.g., an alert) may be disseminated to trading participants to inform them that a hold period has begun, and specifying the duration of the hold period;
c. “IPL period” refers to a pre-set period of time during which the price of a financial instrument is prevented from moving more than an IPL amount above or below the instrument's anchor price. At the end of a given IPL period, the anchor price and/or the IPL amount may be adjusted (e.g., to reflect current market prices), and will remain in effect for a subsequent IPL period;
d. “IPL range” or “IPL band” refers to a range of prices (calculated as the anchor price plus and minus the IPL amount) at which a financial instrument may trade during an IPL period.

With the near instantaneous execution of orders in electronic trading systems, it is possible for prices to move sharply in very short periods of time. Such drastic and rapid price movements can adversely affect financial markets, and even cause a market to crash. The present disclosure addresses this problem by providing a novel interval price limit scheme and system for preventing such rapid and drastic price movements.

In a most general sense, the substance of the present disclosure may be envisioned as a virtual circuit-breaker that imposes time-based “reasonability limits” on trading activities, particularly those that affect the speed and extent of price movement. These reasonability limits may include, for example, a predetermined price range within which all trading is permitted. Attempts to initiate or execute trades that violate the reasonability limits, however, will ‘trip’ the circuit breaker, thereby preventing the unwanted trading activity. Contrary to conventional ‘circuit breakers,’ however, the present disclosure does not completely turn-off or prevent all trading activities. Instead, the present disclosure only suppresses those activities that violate the reasonability limits imposed by the novel scheme and system provided herein, while at the same time permitting trading activities that remain within the reasonability limits to continue.

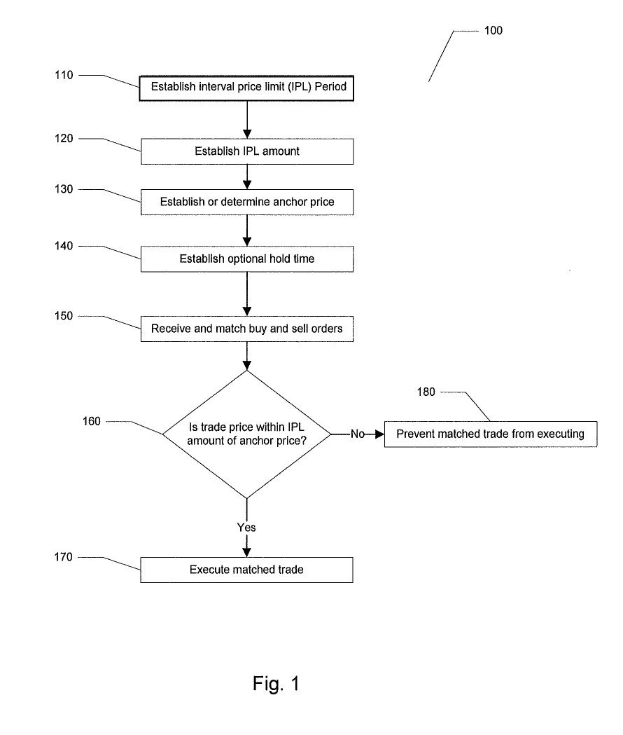

The novel concepts and features described herein may be better understood with reference to FIG. 1, which illustrates an exemplary method 100 of limiting price movement of a financial instrument in accordance with the present disclosure. Notably, this exemplary method 100 may be carried out by one or more computing devices comprising one or more processors configured to execute computer executable instructions stored in memory. Such computing devices may include, without limit, one or more computers (desk top or laptop), servers, smartphones, hand-held communication devices, tablets, kiosks, and/or any other suitable computing/communication devices. In addition, the computing devices may include one or more stand-alone devices, such as a stand-alone server, or they may be a part of a larger system or network, such as (for example) an electronic exchange system. Optionally, the one or more computing devices may further be configured to include one or more matching engine modules configured to match orders (e.g., buy and sell orders) received via the one or more computing devices, and to execute trades based on the matched orders. For purposes of this illustration, the one or more computing devices shall collectively be referred to as a server, such as an exchange server, for example.

Further, although the steps of the exemplary method 100 are shown in a particular sequence, such steps are not limited thereto. In fact, many of the steps may occur in parallel.

Returning now to FIG. 1, the exemplary method 100 includes as an initial step establishing an interval price limit (IPL) period that defines a predetermined length of time commencing at a start time (110). During this IPL period, all trading activities within pricing limits defined via an IPL amount and an anchor price (further described below) are permitted to continue. Next, at 120, an IPL amount is established. This IPL amount defines a permissible increase and decrease in an anchor price of a particular financial instrument during the IPL period. Thus, adding the IPL amount to the anchor price defines an upper price limit, and subtracting the IPL amount from the anchor price defines a lower price limit. Collectively, these upper and lower price limits, together with all prices in between, define a range of prices (i.e., the IPL range) at which trading activities involving the particular financial instrument are permitted. By way of example, if an anchor price is determined (or set) to $10.00, and the IPL amount is established to be $0.25, then the upper price limit of the IPL range is $10.25 (calculated as the anchor price+the IPL amount) and the lower price limit of the IPL range is $9.75 (calculated as the anchor price−the IPL amount).

As indicated above, the anchor price refers to a benchmark or a current market value or price level of the particular financial instrument. This anchor price may be determined or established (130) in any number of ways. For example, the anchor price may be established by determining a most recent trade price for the particular financial instrument. Alternatively, the anchor price may be determined based on a current market price (for example, at the start of an IPL period) for the particular financial instrument. The anchor price may also be determined based on a spread differential (in price) of the financial instrument over two specific time periods. For example, assume that a July contract is the prompt month for a particular futures contract, that its current anchor price is $25.50, that the spread between the July and October contracts is −30 points (that is, July is 30 points over October), and that the spread difference between the July and March contracts is −70 points (that is, July is 70 points over March). In this example, the anchor price for the October contract would be $25.20 (the July anchor price of $25.50 minus 30 points) and the anchor price for the March contract would be $24.80 (the July anchor price of $25.50 minus 70 points).

Notably, determining or establishing the anchor price (130) may occur before, after and/or concurrently with establishment of any of the IPL period (110) and the IPL amount (120). Further, any of the IPL period, the IPL amount and the anchor price may be established (and/or adjusted) at any time, including at random times, at predetermined time periods, as desired on an ad hoc basis, or upon the occurrence of one or more predefined events.

An optional hold time (140) may also be established to define a specific length of time during which certain trading activities involving prices that are outside of the IPL range are temporarily suspended. This optional hold time may also be established before, after or concurrently with any of the other parameters discussed above, and it may also be established (and/or adjusted) at any time, including at random times, at predetermined time periods, as desired on an ad hoc basis, or upon the occurrence of one or more predefined events.

Notably, any of the foregoing parameters may be established and/or determined based on instructions stored in a server memory, and/or based on instructions or commands received from one or more computing terminals in communication with the server. Once established, each of these parameters may be stored in memory for future use.

Before, concurrently with, or after the IPL period (110), IPL amount (120) and anchor price (130) are determined and/or established, one or more orders (e.g., buy and sell orders) for the particular financial instrument, each having a trade price, are received at the matching engine module(s) (150) following the IPL period start time. Such orders may be of any order type, including (without limit) market orders, stop orders, limit orders, stop-limit orders, etc. In addition, these orders may be received from one or more computing terminals (e.g., one or more computers (desk top or laptop), servers, smartphones, tablets, hand-held communication devices, kiosks, and/or any other suitable computing/communication devices) in communication with the server.

Complimentary orders (e.g., buy and sell orders with corresponding terms and prices) received for the financial instrument during the IPL period are then matched by the matching engine module(s) to generate at least one matched trade (150). The trade price of this matched trade is then compared to the anchor price (160) to determine whether the trade price is within the IPL amount of the anchor price. If the trade price is within the IPL amount of the anchor price (i.e., within the IPL range), the matching engine module(s) proceed to execute the matched trade (170). Otherwise, if the trade price is not within the IPL amount of the anchor price, the matching engine module(s) is prevented from executing the matched trade (180).

As an option, if at least one of the orders received at (150) is a stop order having a limit price that is not within the IPL amount of the anchor price (i.e., the limit price is outside of the IPL range), the limit price may temporarily be adjusted to a price that is within the IPL range, and then additional attempts to match the stop order (at the adjusted limit price) may be initiated. If the stop order is not matched within a predetermined period of time, the adjusted limit price may be reverted back to its original value. If, however, the original limit price is within the IPL range, no change is made to the order terms and it remains executable at its limit price.

As another option, if it is determined that the trade price of a matched trade is not within the IPL amount of the anchor price, the server may initiate a hold period (not shown) that will last for the hold time established at (140). During this hold period, the server embodying the matching engine module(s) may be configured to prevent the matching engine module(s) from executing matched trades for financial instruments having a trade price that is beyond the IPL amount of the anchor price (i.e., outside of the IPL range) (170), while at the same time executing matched trades for financial instruments having a trade price within the IPL amount of the anchor price (i.e., within the IPL range) (180). For example, if the price of a particular financial instrument drops too quickly, such that its price (as determined by received bids and offers) falls below the lower price limit of the IPL range, a hold period will prevent selling of the financial instrument at prices below the IPL range, while at the same time permitting buyers to buy the financial instrument at prices above the upper price limit of the IPL range. As an option, a hold notification may be generated and transmitted to trading participant devices or terminals.

Other features and operations that may optionally be available during the hold period include (without limit) canceling, amending, or making inactive one or more orders for the financial instrument. These features and operations may be initiated, for example, via one or more computing/communication devices (e.g., trading terminals) that are in communication with the server embodying the matching engine module(s) via, for example, a wired or wireless network. In addition, new orders (having a price within the IPL range) may also be received, matched, and executed by the matching engine module(s) during the hold period. Resting orders existing at the initiation of the hold period may also remain active during the hold period.

Features and operations that may optionally be prevented during the hold period include (without limit) entry of new orders that would result in a matched trade having a trade price beyond the IPL amount of the anchor price, and amendment of existing orders (i.e., orders received by the matching engine module(s) prior to commencement of the hold period) that would result in a matched trade having a trade price beyond the IPL amount of the anchor price. In addition, unfilled market orders that exist at the start of the hold period (or that actually trigger the hold period) may optionally be cancelled at the start of the hold period.

At the conclusion of the IPL period established at (110), one or more of the anchor price, the IPL period duration, the IPL amount, the optional hold time or any other parameter may be adjusted, for example, to reflect current market conditions (e.g., current price of the financial instrument). In addition, a subsequent IPL period (having the same or an adjusted duration as the IPL period established at 110) may commence, during which trades may be generated, matched and executed. As with the IPL period established at 110, matched trades having trade prices that are not within the IPL range (i.e., within the IPL amount of the anchor price) pertaining to this subsequent IPL period will be prevented from executing. In addition, a subsequent optional hold period may be triggered if attempts are made to violate IPL range.

As indicated above, matched trades having trade prices that are outside of an IPL range may trigger or initiate a hold period. Other actions that may initiate a hold period include (without limit) a bid attempt, either to rest or transact on a resting offer, above the upper price limit of an IPL range; or an offer attempt to rest or transact on a resting bid below the lower price limit of the IPL range. Such bid and offer attempts may be provided as market orders, limit orders, elected stop orders, etc.

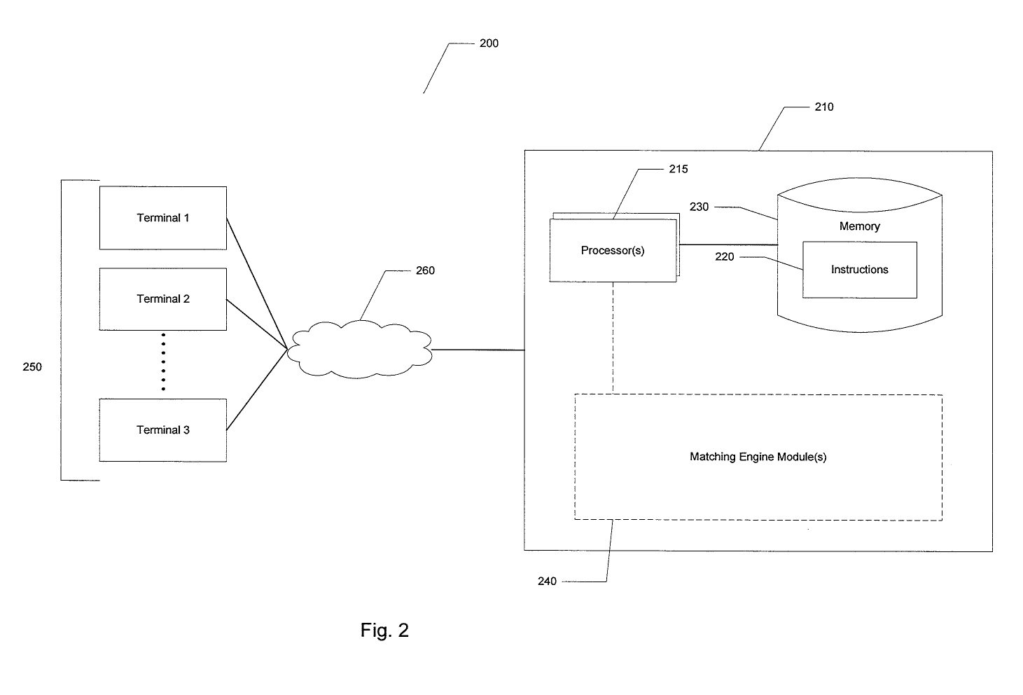

Turning now to FIG. 2, an exemplary system (200) for limiting price movement of a financial instrument in accordance with the present disclosure is shown. The various components described herein with respect to the system 200 may be described in the general context of comprising computer-executable instructions, such as program modules, being executed by a computer. Generally, program modules may include routines, programs, objects, components, data structures, or the like that perform particular tasks or implement particular abstract data types.

Included in the system (200) are one or more computing devices (210) comprising one or more processors (215) configured to execute computer executable instructions (220) stored in memory (230). Such computing devices (210) may include, without limit, one or more computers (desk top or laptop), servers, smartphones, tablets, hand-held communication devices, kiosks, or any other suitable computing/communication devices. In addition, the computing devices (210) may include one or more stand-alone devices, such as a stand-alone server, or they may be a part of a larger system or network, such as (for example) an electronic exchange system. The one or more computing devices (210) may further be configured to include one or more matching engine modules (240) generated, for example, by the one or more processors (215) executing instructions (220) stored in memory (230). These matching engine module(s) (240) are optionally configured to match orders (e.g., buy and sell orders) received via one or more computing terminals (250) in communication with the one or more computing devices (210) via, for example, a wired or wireless communications network (260). The matching engine module(s) (240) may also be configured to execute trades based on the matched orders. For purposes of this illustration, the one or more computing devices (210) shall collectively be referred to as a server, such as an exchange server, for example.

The one or more computing terminals (250) may include (without limit) one or more computers (desk top or laptop), servers, smartphones, tablets, hand-held communication devices, kiosks, and/or any other suitable computing/communication devices. Collectively, the one or more computing terminals shall simply be referred to as a terminal or terminals (250).

In operation, the server (210) is configured to establish and/or determine an IPL period that commences at a start time, an IPL amount, an anchor price. As indicated above, the anchor price may be determined or established in any number of ways, including based on a most recent trade price of a particular financial instrument, on a current market price for the particular financial instrument, or on a spread differential of the financial instrument over two specific time periods.

The server (210) may also be configured to establish a hold time that defines a specific length of time during which certain trading activities involving prices that are outside of an IPL range (which is defined based in the IPL amount and the anchor price) are temporarily suspended.

Notably, any of the IPL period, IPL amount, anchor price and optional hold time may be established or determined based on instructions (220) stored in the memory (230), and/or based on instructions or commands received from one or more of the terminals (250) in communication with the server (210). Once established, each of these parameters may be stored in memory (230) for future use and/or adjustment. In addition, these parameters may be determined or established before, after and/or concurrently with establishment of any other of these parameters. Further, the IPL period, the IPL amount, the anchor price and the hold time may be established (and/or adjusted) at any time, including at random times, at predetermined time periods, as desired on an ad hoc basis, or upon the occurrence of one or more predefined events.

Following the IPL period start time, one or more orders (e.g., buy and sell orders) for a particular financial instrument, each having a trade price, may be received at the matching engine module(s) (240) via the server (210). Such orders may be of any order type, including (without limit) market orders, stop orders, limit orders, stop-limit orders, etc. In addition, these orders may be received from the one or more terminals (250) in communication with the server (210).

Upon receiving the orders, the matching engine module(s) (240) is configured to process and identify complimentary orders (e.g., buy and sell orders having matching terms/prices) and generate matched trades. The trade price of each matched trade is then compared to the anchor price to determine whether the trade price is within the IPL amount of the anchor price. If the trade price of a matched trade is within the IPL amount of the anchor price (i.e., within the IPL range), the matching engine module(s) (240) proceed to execute the matched trade. Otherwise, if the trade price of a matched trade is not within the IPL amount of the anchor price, the matching engine module(s) (240) is prevented from executing the matched trade.

As an option, if at least one of the orders received by the matching engine module(s) (240) is a stop order having a limit price that is not within the IPL amount of the anchor price (i.e., the limit price is outside of the IPL range), the server (210) may be configured to temporarily adjust the limit price to a price that is within the IPL range, and then additional attempts (by the matching engine module(s) (240)) to match the stop order (at the adjusted limit price) may be initiated. If the stop order is not matched within a predetermined period of time, the adjusted limit price may be reverted back to its original value.

As another option, if it is determined that the trade price of a matched trade is not within the IPL amount of the anchor price, the server (210) may initiate a hold period that will last for the pre-established hold time. During this hold period, the matching engine module(s) are presented (240) from executing matched trades for financial instruments having a trade price that is beyond the IPL amount of the anchor price (i.e., outside of the IPL range), while at the same time continuing to execute matched trades for financial instruments having a trade price within the IPL amount of the anchor price (i.e., within the IPL range). As an option, a hold notification may be generated and transmitted by the server (210) to the one or more terminals (250).

If a hold period is initiated, the server (210) may be configured to maintain certain features and operations available during the hold period. Such features and options include (without limit): receiving and implementing commands for canceling, amending, or making inactive one or more orders for the financial instrument. These features and operations may be initiated, for example, via the terminals (250) that are in communication with the server (210). In addition, new orders (having a price within the IPL range) may also be received, matched, and executed by the matching engine module(s) (240) during the hold period. Resting orders existing at the initiation of the hold period may remain active and/or be cancelled.

Additional features and operations that may optionally be prevented during the hold period may include (without limit) entry of new orders (via, for example, the terminals (150)) that would result in a matched trade having a trade price beyond the IPL amount of the anchor price, and amendment of existing orders (i.e., orders received by the matching engine module(s) (240) prior to commencement of the hold period) that would result in a matched trade having a trade price beyond the IPL amount of the anchor price. In addition, unfilled market orders that exist at the start of the hold period (or that actually trigger the hold period) may optionally be cancelled by the server (210)/matching engine module(s) (240) at the start of the hold period.

At the conclusion of an IPL period, one or more of the anchor price, the IPL period duration, the IPL amount, the optional hold time or any other parameter may be adjusted, for example, to reflect current market conditions (e.g., current price of the financial instrument). These adjustments may be initiated, for example, via instructions (220) stored in memory (230) and/or by instructions or commands received from the terminals (250).

In addition, the server (210) may be configured to commence a subsequent IPL period (having the same or an adjusted duration as the initial IPL period), during which trades may be generated, matched and executed by the matching engine module(s) (240). As with the initial IPL period, matched trades having trade prices that are not within the IPL range (i.e., within the IPL amount of the anchor price) pertaining to this subsequent IPL period will be prevented from executing.

Attempts to violate the IPL range (i.e., attempts to trade at prices beyond the IPL range) may cause the server (210) to trigger an optional hold period. Other actions that may cause the server (210) to initiate a hold period include receiving a bid, either to rest or transact on a resting offer, above the upper price limit of an IPL range; or receiving an offer to rest or transact on a resting bid below the lower price limit of the IPL range. Such bid and offer attempts may be provided as market orders, limit orders, elected stop orders, etc.

The better understand the concepts and features described herein, the following example is provided. The financial instrument involved in this example shall be a futures contract that is trading at a price of $25.25 at the start of a new IPL period. For purposes of this example, the start time of this new IPL period is assumed to be 11:00:00 with a duration of fifteen (15) seconds. This means that the IPL period will end at 11:00:15.

It is also assumed that anchor price of the futures contract is set to reflect the current trading price of $25.25 and that the IPL amount is set to fifty (50) points (i.e., $0.50). As a result, the IPL range (i.e., the range of prices at which the futures contract will be permitted to trade) is between $24.75 (anchor price−IPL amount) and $25.75 (anchor price+IPL amount).

Lastly, it is assumed that that the optional IPL hold period time is set to thirty (30) seconds. Thus, if certain impermissible trading activity triggers a hold period, the hold period will last for 30 seconds.

Scenario 1—In this first scenario, it is assumed that during the IPL period, orders received for the futures contract include prices that remain within the IPL range. It is also assumed that the market price for the futures contract at the end of the IPL period (i.e., 11:00:15) is $25.10. In this scenario, since the price of the futures contract does not reach the upper or lower end of the IPL range, no hold period is triggered. Thus, at the conclusion of the initial IPL period, a new IPL period will begin at time 11:00:15 and run until 11:00:30.

Since the market price of the futures contract has changed (from $25.25 to $25.10), the anchor price for this new IPL period is adjusted to reflect the current market price (i.e., $25.10). This change in anchor price affects a change in the IPL range, which is now between $24.60 and $25.60 (calculated by adding the IPL amount to and subtracting it from the anchor price at the start of this new IPL Period).

Scenario 2—During the new IPL period commenced at the end of Scenario 1, it is assumed that the futures contract is trading at increasingly higher prices, and that it has been determined that a next trade for the futures contract, occurring at time 11:00:20, will be at a price that is beyond the upper limit of the IPL range (e.g., at a price that is $25.61 or higher). Based on this determination, an IPL hold period is triggered at time 11:00:20 to prevent trades at prices beyond the IPL range. This IPL hold period will last for 30 seconds (until time 11:00:50) based on the pre-established hold time. During the IPL hold period, the trade price for the futures contract remains subject to the 25.60 to 24.60 IPL range set at the start of this new IPL period. At the end of the IPL hold period (i.e., 11:00:50) a third IPL Period begins and the IPL range for this third IPL period may be calculated based on a new anchor price (e.g., the trading price of the futures contract at the end of the IPL hold period) plus/minus the 50 point IPL amount.

The foregoing examples are provided merely for the purpose of explanation and are in no way to be construed as limiting. While reference to various embodiments are shown, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as are within the scope of the appended claims.

1. A method of limiting price movement of a financial instrument, comprising:
providing an exchange server comprising at least one matching engine module, said exchange server comprising at least one processor executing instructions that cause the exchange server to perform the steps of:
establishing an interval price limit (IPL) period that defines a predetermined length of time commencing at a start time;
establishing an IPL amount that defines a permissible increase or decrease in an anchor price of a financial instrument during the IPL period, said anchor price being the price of the financial instrument at the start time;
receiving and matching, via the at least one matching engine module, at least one buy order and at least one sell order for the financial instrument during the IPL period, thereby generating at least one matched trade having a trade price;
comparing the trade price to the anchor price; and
if the trade price is within the IPL amount of the anchor price, executing the matched trade,
otherwise, if the trade price is not within the IPL amount of the anchor price, preventing the matched trade from executing.

2. The method of claim 1, further comprising:
initiating a hold period having a predetermined hold time during which the at least one matching engine module:
is prevented from executing matched trades for the financial instrument having a trade price that is beyond the IPL amount of the anchor price, and
executes matched trades for the financial instrument having a trade price within the IPL amount of the anchor price.

3. The method of claim 2, further comprising:
canceling, amending, or making inactive at least one order for the financial instrument during the hold period.

4. The method of claim 2, further comprising:
during said hold period,
preventing entry of new orders that would result in a matched trade having a trade price beyond the IPL amount of the anchor price, and
preventing amendment of existing orders that would result in a matched trade having a trade price beyond the IPL amount of the anchor price, said existing orders having been received by said matching engine module prior to commencement of said hold period.

5. The method of claim 2, further comprising:
receiving at least one new order for the financial instrument during the hold period, said new order having a price within the IPL amount of the anchor price.

6. The method of claim 5, further comprising:
matching said at least one new order with at least one other order to generate a new matched trade; and
executing the new matched trade.

7. The method of claim 1, further comprising:
at a conclusion of the IPL period,
adjusting the anchor price to reflect a current price of the financial instrument;
commencing a second IPL period; and
generating at least one other matched trade during the second IPL period.

8. The method of claim 7, further comprising:
preventing the at least one other matched trade from executing and initiating a hold period if the at least one other matched trade has a trade price that is not within the IPL amount of the adjusted anchor price.

9. The method of claim 1, wherein at least one of the orders received is a stop-limit order having a limit price.

10. The method of claim 9, wherein a last traded price of the financial instrument triggers the stop order, and wherein the limit price is not within the IPL amount of the anchor price, the method further comprising:
temporarily adjusting the limit price to a price that is within the IPL amount of the anchor price; and
attempting to match the stop order at the adjusted limit price.

11. The method of claim 10, further comprising:
reverting the limit price back to its original value if the stop order is not matched at the adjusted limit price within a predetermined period of time.

12. The method of claim 2, further comprising:
generating an alert message once the hold period is triggered; and
transmitting the alert to one or more trading terminals in communication with the exchange server.

13. A system for limiting price movement of a financial instrument, comprising:
one or more servers comprising:
one or more processors configured to execute computer executable instructions stored in a memory, and
a matching engine module,
said processors executing instructions that cause the one or more servers to:
establish an interval price limit (IPL) period that defines a predetermined length of time commencing at a start time;
establish an IPL amount that defines a permissible increase or decrease in an anchor price of a financial instrument during the IPL period, said anchor price being the price of the financial instrument at the start time;
receive and match, via the matching engine module, at least one buy order and at least one sell order for the financial instrument during the IPL period, thereby generating at least one matched trade having a trade price;
compare the trade price to the anchor price; and
if the trade price is within the IPL amount of the anchor price, execute the matched trade,
otherwise, if the trade price is not within the IPL amount of the anchor price, prevent the matched trade from executing.

14. The system of claim 13, wherein the one or more servers are further configured to initiate a hold period having a predetermined hold time during which the matching engine module is prevented from executing matched trades for the financial instrument having a trade price that is beyond the IPL amount of the anchor price, and during which the matching engine module executes matched trades for the financial instrument having a trade price within the IPL amount of the anchor price.

15. The system of claim 14, wherein the one or more servers are further configured to execute instructions or commands for canceling, amending, or making inactive at least one order for the financial instrument during the hold period.

16. The system of claim 14, wherein during the hold period, the one or more servers are further configured to prevent entry of new orders that would result in a matched trade having a trade price beyond the IPL amount of the anchor price, and to prevent amendment of existing orders that would result in a matched trade having a trade price beyond the IPL amount of the anchor price, said existing orders having been received by said matching engine module prior to commencement of said hold period.

17. The system of claim 14, wherein the one or more servers are further configured to receive at least one new order for the financial instrument during the hold period, said new order having a price within the IPL amount of the anchor price.

18. The system of claim 17, wherein the matching engine module is further configured to match said at least one new order with at least one other order to generate a new matched trade; and
execute the new matched trade.

19. The system of claim 13, wherein the one or more servers are further configured to:
at a conclusion of the IPL period,
adjust the anchor price to reflect a current price of the financial instrument;
commence a second IPL period; and
generate at least one other matched trade during the second IPL period.

20. The system of claim 19, wherein the one or more servers are further configured to prevent the matching engine module from executing the at least one other matched trade, and to initiate a hold period if the at least one other matched trade has a trade price that is not within the IPL amount of the adjusted anchor price.

21. The system of claim 13, wherein at least one of the orders received is a stop-limit order having a limit price.

22. The system of claim 21, wherein a last traded price of the financial instrument triggers the stop order, and wherein the limit price is not within the IPL amount of the anchor price, said one or more servers being further configured to:
temporarily adjust the limit price to a price that is within the IPL amount of the anchor price; and
attempt to match, via the matching engine module, the stop order at the adjusted limit price.

23. The system of claim 22, wherein the one or more servers are further configured to revert the limit price back to its original value if the stop order is not matched at the adjusted limit price within a predetermined period of time.

24. The system of claim 14, wherein the one or more servers are further configured to:
generate an alert message once the hold period is triggered; and
transmit the alert to one or more trading terminals in communication with the exchange server.
